(19) United States
(12) Patent Application Publication
(10) Pub. No.: US 2005/0052317 A1
(43) Pub. Date: Mar. 10, 2005

(54) Combination navigation satellite receivers and communications devices

(75) Inventors: Paul W. McBurney, San Francisco, CA (US); Authur N. Woo, Cupertino, CA (US); France Rode, Los Altos, CA (US)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(73) Assignees: eRide, Inc.; Seiko Epson Corporation

(21) Appl. No.: 10/656,078

(22) Filed: Sep. 4, 2003

(51) Int. Cl. G01S 5/14

(52) U.S. Cl. 342/357.1

(57) ABSTRACT

A combination of a navigation satellite receiver and a communication device exchanges precise synthesized frequencies and clocks between the navigation satellite receiver and the communication device. In one embodiment, a TCXO crystal serves as a reference for the navigation satellite receiver and locking onto the satellite transmissions allows highly accurate frequency synthesis and clock generation by it for the communication device. In another embodiment, a VCO primarily affiliated with the communication device serves as a basic reference for the navigation satellite receiver, and subsequent locking onto the satellite transmissions again allows highly accurate frequency synthesis and clock generation for the communication device. In a further embodiment, a VCO primarily affiliated with the communication device serves as a basic reference for the navigation satellite receiver after it locks onto the communications systems standards. The navigation satellite receiver therefore has reduced clock uncertainty and can initialize and track satellites much faster than otherwise.

### 1. FIELD OF THE INVENTION

The present invention relates to combinations of navigation satellite receivers and communication devices, and more particularly to sharing crystal oscillators between GPS receivers and cellphone handsets.

### 2. DESCRIPTION OF THE PRIOR ART

Most consumer electronic devices are mass produced and their sales are very dependent on how they are priced. One way to offer better prices is to reduce manufacturing costs, e.g., the cost of labor and the components used. Combinations of navigation satellite receivers and communication devices are now available, and many conventional commercial products provide one set of crystals and crystal oscillators for the navigation satellite receiver part, and a separate set for the communication devices.

One of the present inventors, Paul McBurney, together with some others, have recently filed several United States patent applications for inventions relating to GPS receivers. These are summarized in Table II. All such patent applications have been assigned to the same Assignees, and are incorporated herein by reference.

TABLE II

| Docket | | | USPTO | USPTO | |
|---|---|---|---|---|---|
| No. | Title | Inventors | Filing | Ser. No. | U.S. Pat. No. |
| 734-01 | Navigation satellite receiver and Method of | P. McBurney, | 11-Oct.-2000 | 09/687,044 | 6,437,734 |
| | | A. Woo | | | Aug. 20, 2002 |
| 734-02 | Infrastructure-Aiding for Satellite | P. McBurney, | 28-Feb.-2001 | 09/797,521 | 6,473,030B1 |
| | Navigation satellite receiver and Method | A. Woo | | | Oct. 29, 2002 |
| 734-03 | High sensitivity GPS Receiver and | P. McBurney, | 19-Feb.-2002 | 10/079,245 | |
| | Reception | A. Woo | | | |
| 734-04 | Total Correction Strategy | Stephen J, | 19-Feb.-2002 | 10/079,217 | |
| | | Edwards, | | | |
| | | P. McBurney | | | |
| 734-05 | Method and System for Position | S. Edwards, | 19-Feb.-2002 | 10/079,244 | |
| | Calculation from Calculated Time | P. McBurney | | | |
| 734-06 | Computing Network Path Delays so | H. Matsushita, | 19-Feb.-2002 | 10/079,251 | |
| | Accurate Absolute Time can be Forwarded | P. McBurney | | | |
| | from a Server to a Client | | | | |
| 734-07 | No Preamble Frame Sync | Akira Kimura, | 19-Feb.-2002 | 10/079,250 | |
| | | P. McBurney | | | |
| 734-08 | Thin Client | P. McBurney, | 19-Feb.-2002 | 10/079,249 | 6,584,404 |
| | | C. Rasmussen, | | | Jun. 24, 2003 |
| | | F. Vaucher, | | | |
| | | K. Victa | | | |
| 734-09 | Software Crystal Oscillator | H. Matsushita, | 19-Feb.-2002 | 10/079,248 | 6,509,870B1 |
| | | P. McBurney | | | Jan. 21. 2003 |
| 734-10 | High Sensitivity Infrequent Use of Sensors | P. McBurney, | 19-Feb.-2002 | 10/079,247 | 6,559,795 |
| | | K. Victa | | | May 6, 2003 |
| 734-11 | Real Time Clock (RTC) | P. McBurney | 19-Feb.-2002 | 10/079,253 | |
| 734-12 | Shared Reference Station | C. Rypinski, | 19-Feb.-2002 | 10/079,252 | |
| | | M. Junkar | | | |
| 734-13 | Client-Aided Doppler Estimation | P. McBurney, | 07-Aug.-2002 | 10/215,138 | |
| | | W. J. Morrison | | | |
| 734-15 | Synthetic Nav-Data For A High-Sensitivity | P. McBurney, | not yet | | |
| | Satellite Positioning System Receiver | W. J. Morrison | filed | | |

There is a need for a less expensive-to-produce combination of a navigation satellite receiver and a communication device.

### SUMMARY OF THE INVENTION

Briefly, a combination of a navigation satellite receiver and a communication device embodiment of the present invention exchanges precise synthesized frequencies and clocks between the navigation satellite receiver and the communication device. In one embodiment, a TCXO crystal serves as a reference for the navigation satellite receiver and locking onto the satellite transmissions allows highly accurate frequency synthesis and clock generation by it for the communication device. In another embodiment, a VCO primarily affiliated with the communication device serves as a basic reference for the navigation satellite receiver, and subsequent locking onto the satellite transmissions again allows highly accurate frequency synthesis and clock generation for the communication device. In a further embodiment, a VCO primarily affiliated with the communication device serves as a basic reference for the navigation satellite receiver after it locks onto the communications systems standards. The navigation satellite receiver therefore has reduced clock uncertainty and can initialize and track satellites much faster than otherwise.

An advantage of the present invention is that a system and method is provided for a navigation receiver to operate accurately with less than a full ephemeris for any particular GPS satellite.

These and other objects and advantages of the present invention will no doubt become obvious to those of ordinary skill in the art after having read the following detailed description of the preferred SPS receivers which are illustrated in the various drawing figures.

### IN THE DRAWINGS

FIG. 1 is a schematic diagram of a combination GPS satellite navigation receiver part and communication device system embodiment of the present invention in which the communication device's VCO provides a reference frequency assist to the GPS part;

FIG. 2 is a schematic diagram of a combination GPS satellite navigation receiver and communication device system embodiment of the present invention in which the communication VCO device's provides a reference frequency assist to the GPS part and therefore eliminates a GPS crystal oscillator; and

FIG. 3 is a schematic diagram of a multiple re-use of frequencies in a combination GPS satellite navigation receiver and communication device system embodiment of the present invention.

### DETAILED DESCRIPTION OF THE PREFERRED EMBODIMENT

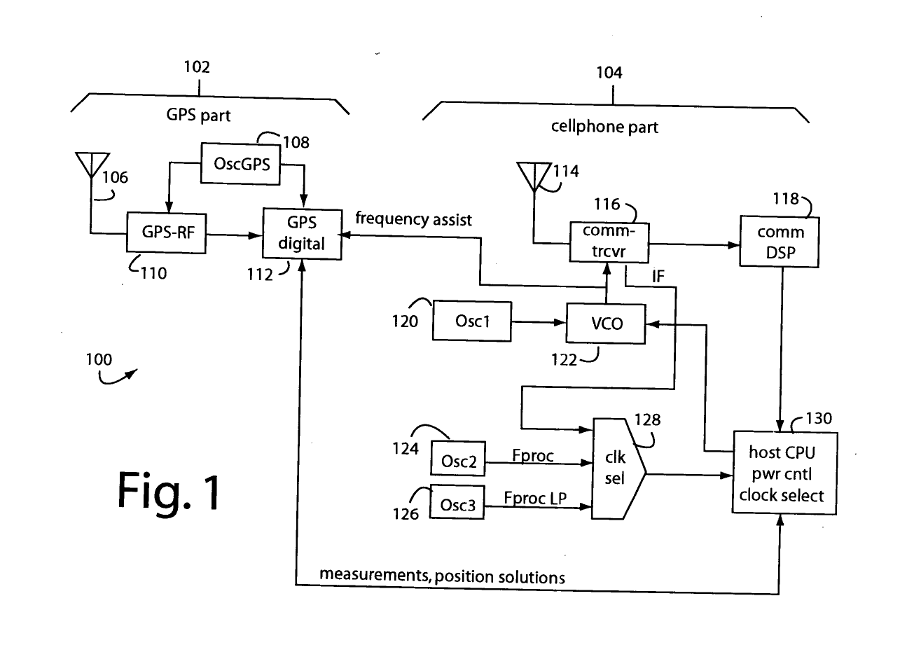

FIG. 1 illustrates a basic integrated combination of a satellite navigation receiver and communication device system embodiment of the present invention, and referred to by the general reference numeral 100. The system 100 has two parts, including a navigation receiver in the form of a global position system (GPS) receiver 102, and communication device in the form of a cellphone 104 that provides reference frequency assistance to the GPS part 102. The GPS part 102 is either a self-contained positioning model or a measurement model with positioning code executed on a host CPU.

In general, the present invention provide for sharing of oscillators to reduce the number of crystals and crystal oscillators needed in the implementations, e.g., to save on the manufacturing costs. In a mass production market, small price reductions frequently results in significantly higher sales volumes.

In system 100, the GPS part 102 comprises a GPS patch antenna 106, a GPS-oscillator 108, a GPS RF-receiver 110, and a GPS digital signal processor 112. The GPS part 102 can simply take measurements and forward them to a host CPU for position solution processing, or process the position solutions itself. Sharing a highly capable host CPU with the cellphone part 104 provides a way to reduce overall costs.

The cellphone part 104 comprises a cellphone antenna 114, a communications transceiver 116, a cellphone digital signal processor (DSP) 118, a first oscillator (osc1) 120 that feeds a voltage controlled oscillator (VCO) 122, a second oscillator (osc2) 124, a third oscillator (osc3) 126, and a clock selector 128. A host CPU 130 provides high level functionality to both the GPS part 102 and the cellphone part 104.

Several crystal re-use and frequency sharing arrangements are possible in embodiments of the present invention. For example, the GPS part can be arranged to supply a reference crystal frequency to the phone part to re-use a crystal, e.g., to eliminate the need for a VCO crystal oscillator in the communications device. The GPS could also provide accurate frequency to the communications device to improve its acquisition and tracking of the communications VCO; or/and provide a phone processor clock in both nominal and high power consumption environments; or/and be used to source a frequency synthesizer to supply any continuous frequency within its generation range; or/and can supply time events to the host CPU 130 that are accurate GPS time events; or/and can supply time events in host CPU time frame via an offset from GPS system time; or/and can supply real-time-clock capabilities to host CPU.

The oscillators referred to herein include OscGPS 108 (FIG. 1) which generates all frequencies for GPS RF and digital processing. Osc1 120 produces a reference for the communications VCO and synthesizes all the RF frequencies needed for the communications device, e.g., a high RF frequency and an intermediate IF frequency. The Osc2 124 produces “Fproc” as the normal operating frequency for the communications CPU, and Osc3 126 for low-power frequency “FprocLP” used for idle, standby or off times.

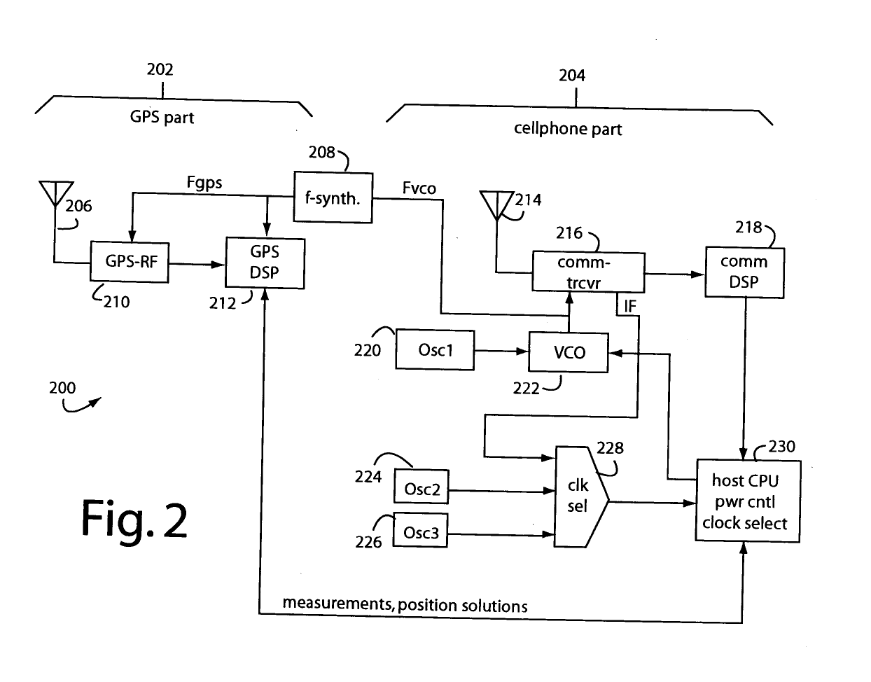

FIG. 2 illustrates another integrated combination of a satellite navigation receiver and communication device system embodiment of the present invention, and referred to by the general reference numeral 200. The system 200 has a global position system (GPS) receiver part 202, and a cellphone part 204 wherein the cell phone part 204 provides a reference frequency good enough to eliminate the need for a separate GPS crystal oscillator in the GPS part 202.

In system 200, the GPS part 202 comprises a GPS patch antenna 206, a GP-frequency synthesizer 208, a GPS RF-receiver 210, and a GPS digital signal processor 212. The GPS-synthesizer 208 eliminates the need of a GPS crystal oscillator, e.g., GPS-oscillator 108, by synthesizing the GPS reference frequency (Fgps) directly from the VCO frequency (Fvco). When Fvco is locked by the communications system reference standards, the frequency is very exact and dependable.

The cellphone part 204 comprises a cellphone antenna 214, a communications transceiver 216, a cellphone digital signal processor (DSP) 218, a first oscillator (osc1) 220 that feeds a voltage controlled oscillator (VCO) 222, a second oscillator (osc2) 224, a third oscillator (osc3) 226, and a clock selector 228. A host CPU 230 provides high level functionality to both the GPS part 202 and the cellphone part 204. The first oscillator (osc1) 220 is typically a temperature compensated crystal oscillator (TCXO). The third oscillator (osc3) 226 is typically a 32-KHz real time clock (RTC) that can be based on a watch crystal.

One advantage of GPS is that high accuracy positions can be obtained even while depending on low cost crystal oscillator reference frequency sources. But problems can arise when the GPS reference frequency is derived from a communications VCO. Frequency jumps can afflict the GPS reference frequency when the communications VCO transitions between different cell towers, e.g., because of different base transmitter frequency offsets, and because the velocity vector to respective towers can be very different. The resulting delta-Doppler can be significant. There can also be residual uncompensated frequency errors in the automatic frequency compensation (AFC) frequency loop of the communications device. The communications device can tolerate larger frequency errors in comparison to the data rate that can be tolerated by the GPS receiver. Reducing the frequency that the AFC loop updates can be used to minimize data processing and CPU loading. The residual frequency error can increase when the communications device goes into standby mode with the frequency control in open loop and drifts uncorrected.

Frequency stability is important in communication systems, but the data rate is much higher than the typical frequency errors so it can still be properly demodulated. The data is detected at a much higher bandwidth than the low frequency VCO hold off error. Unlike the GPS part, precise carrier tracking is not needed as long as the data can be demodulated properly. When frequency updates are received, such are band limited to reduce jump inputs into the VCO. But, signal outages and tower changes will nevertheless introduce frequency errors during open loop operation that adversely impact the GPS operation.

High frequency changes in the reference frequency for the GPS affects searching, and not the ultimate accuracy of GPS position solutions. Some problems accompany using a GPS reference frequency derived from a VCO. A NavData collection error occurs if the frequency jump during the 20-msec period is more than a half cycle of the data bit and the data will not be decoded correctly. A frequency assistance error occurs if the VCO error is driven by tower frequency error, communications velocity, or loop error. The GPS receiver encounters error when trying to cross-calibrate with the communications device frequency, e.g., a frequency assistance method embodiment of the present invention.

Sensitivity loss can occur. Narrow band integration is preferred in high sensitivity GPS receivers. The VCO frequency error causes an error in GPS measurement. If it is common mode, it effects the GPS drift estimate. An error in such frequency estimate causes errors in the frequency prediction of where to acquire the satellite. Any error increases the amount of search required, thus delaying the fix. Frequency errors in tracking the GPS signal cause position errors for long measurement integrations required for high sensitivity. An error in frequency during long correlations spreads the energy across many pseudorange code phases. Thus, signal power is lost and the true peak is not known.

In a PDC-telephone network, the typical error budget includes 0.1 PPM base station stability, 100 mph=44 mls=230 Hz=0.15 PPM, loop budget 0.2 PPM, all for total of almost 0.45 PPM. Therefore using a VCO as a frequency source for a GPS receiver is practical. On the other hand, modern low-cost TCXO oscillators are able to provide similar or better stability if software modeling is used.

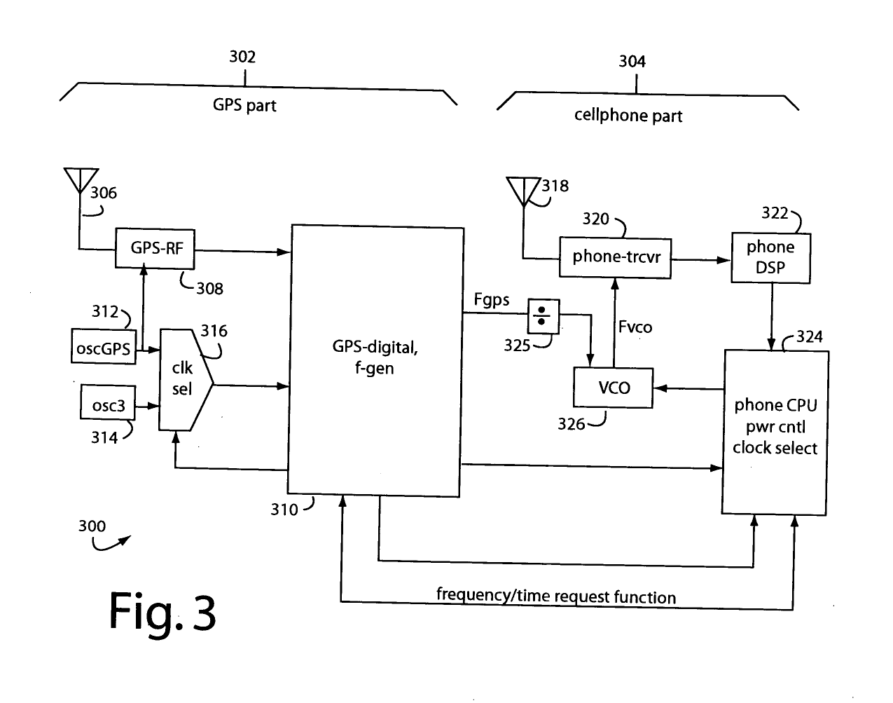

FIG. 3 illustrates a multiple re-use of frequencies in an integrated combination of a satellite navigation receiver and communication device system embodiment of the present invention, referred to by the general reference numeral 300. The system 300 has a GPS part 302 and a cellphone part 304 that are both integrated within the same portable or handheld device. The GPS part 302 includes a GPS antenna 306, a GPS RF-receiver 308, a GPS digital processor and frequency generator (chip) 310, a GPS oscillator (oscGPS) 312, and a low frequency oscillator (osc3) 314. A clock selector 316 selects between normal and low-power operation, e.g., by clock frequency choices. The cellphone part 304 includes a cellphone antenna 318, a communications transceiver 320, a digital signal processor 322, a phone CPU-power control-clock selector 324, a divider 325, and a voltage controlled oscillator (VCO) 326.

The divider 325 is included to increase the relative stability and accuracy of the reference frequency applied to VCO 326. The cellphone part 304 is not as dependent on its cellphone base station providing good reference frequencies for proper CDMA operation when it has very accurate references locally. If all the mobile phones operating in a vase station area had such GPS-provided reference signals, the base station would not need to be equipped with expensive atomic clocks.

Communication devices generally need their own faster processor crystals, since the typical VCO oscillator operates in the relatively slow 10-13 MHz range. Some processors need to be able to switch to even higher frequencies for special communications functions. An intermediate frequency (IF) used in the down conversion process and produced in the RF chip can be used to run applications that require more computation resources. A low frequency oscillator is selected for low-power time maintenance, and is typically a 32-KHz crystal.

At turn-on, the GPS chip 310 loads a default startup processor clock selection for the phone CPU 324, e.g., from a non-volatile memory location. The host processor clock frequency is generated by multiplying GPS clock for input to a numeric controlled oscillator (NCO). Such NCO can then be digitally programmed to generate any output frequency up to half of its input frequency. The GPS part 302 puts itself into a sleeping, low-power mode and lets the user decide when to use the GPS. A host system begins operating when its clock is stable. The host can then chose different frequencies, via the communication between the host CPU 324 and GPS digital chip 310. The phone part 304 can request a general frequency number by sending a desired frequency. It can control when the VCO is turned onto the frequency to be used, e.g., 12.6 MHz for the Japanese PDC system. If the GPS part 302 is tracking GPS satellites and solving for its frequency error, it can then compensate the requested 12.6 MHz by what it knows to be the error in the GPS crystal. Thus, it can provide a more stable frequency to the communications device VCO 326. If low-power mode is needed, the communications device 304 can request that the GPS part 302 enter low-power mode. It keeps time with the low frequency crystal input from osc3 314. If the GPS oscillator 312 can be made low-power, the 32 kHz oscillator 314 can be eliminated. The GPS part 302 can send interrupts to the phone part 304 on time-events lines to wake certain processes that need to occur at regular but accurate intervals.

The GPS part 302 provides a VCO frequency corrected by GPS satellite time standards, and is very accurate. A variable VCO from the GPS part 302 can be supplied that is responsive to requests from the phone part 304, e.g., for frequency stepping operations needed in frequency-division multiple access (FDMA) systems. An analog sinusoidal voltage can be output by the GPS part 302 to approximate a crystal output. Such may be requested by using bits from the top of an adder for accurate phase. Such phase is converted with a table having more representative levels for a sinusoid rather than the linear counter value. A table value can be converted to an analog signal in a digital to analog converter. The overflow of the adder can also be used to generate a simple 1-bit digital clock frequency. Time interval interrupts can be constructed from combinations of the GPS second and millisecond interrupts in the GPS receiver, and osc3 314. The timing of events can be phased to any time frame of reference by using offsets.

In a method embodiment of the present invention, the number of source oscillators in an integrated combination navigation receiver and cellphone is reduced to two, e.g., a GPS crystal oscillator at about 27-MHz and a watch crystal oscillator at about 32-KHz. A multiplier is connected to the GPS crystal oscillator to produce higher frequencies. Two numeric controlled oscillators (NCO1 and NCO2) are used, respectively, to generate VCO and host CPU frequencies. A time event logic produces time events to the host CPU from combinations of GPS msec interrupts, GPS second pulses, digital offsets, and the watch crystal oscillator.

In general, embodiments of the present invention improve both manufacturing costs and device performance. For example, the navigation receiver supplies a reference crystal frequency to the communications device to re-use a crystal, thus eliminating the need for a second crystal, the communications VCO crystal. And, when the navigation receiver supplies such reference crystal frequency to the communications device, the communications receiver sensitivity is improved because the frequency uncertainty is so much reduced the initial frequency search space can be trimmed. The receiver is thus able to search for signal in the frequency domain using smaller increments or steps, but still be able to find initial lock in a reasonable time.

Although the present invention has been described in terms of the presently preferred SPS receivers, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1-11. (canceled)

12. An integrated satellite navigation receiver and communication device combination system, comprising:
a single portable device that includes a global positioning system (GPS) receiver part (302) and a communications transceiver part (304);
said GPS receiver part (302) including a GPS RF-receiver (308), a GPS digital processor and frequency generator (GPS-chip) (310), a GPS oscillator (oscGPS) (312), a lower-frequency oscillator (osc3) (314) operating at about 32-KHz, and a clock selector (316) for selecting between clock frequency choices for normal and low-power operation;
said communications transceiver part (304) including a cellphone transceiver (320), a digital signal processor (DSP) (322), a phone host CPU (324), a divider (325), and a voltage controlled oscillator (VCO) (326);
wherein, at turn-on, the GPS-chip (310) loads a default startup processor clock selection for said phone CPU (324), and a host processor clock frequency is generated by multiplying a GPS clock that is input to a numeric controlled oscillator (NCO) that can then be digitally programmed to generate any output frequency up to half of its input frequency; and
wherein, if the GPS receiver part (302) is tracking GPS satellites and solving for frequency error, it compensates such requested frequency by its computing of the error in said GPS oscillator (oscGPS) (312) to provide a more stable frequency to said VCO (326).

13. The system of claim 12, wherein:
said host CPU (324) is enabled to chose different frequencies via a communication link between the host CPU (324) and said GPS-chip (310); and
said communications transceiver part (304) can request a particular output frequency, and it can control when said VCO (326) begins outputting such frequency.

14. The system of claim 12, wherein:
the communications device (304) sends a request for said GPS receiver part (302) to enter said low-power mode if a low-power mode is to be engaged.

15. The system of claim 12, wherein:
time is maintained with a low frequency crystal with an input from osc3 (314).

16. The system of claim 12, wherein:
said GPS receiver part (302) sends interrupts to the communications transceiver part (304) that wake certain processes.

17. The system of claim 12, wherein:
the GPS receiver part (302) puts itself into a sleeping, low-power mode and enables a user to decide when to use the GPS function.

18. The system of claim 12, further comprising:
a variable-VCO output from said GPS receiver part (302) responsive to requests from said communications transceiver part (304) to generate particular frequencies, waveforms, and phasing.

19. The system of claim 12, further comprising:
a time interval interrupt constructed from combinations of GPS-second and GPS-millisecond interrupts included in said GPS receiver part (302), with event timing being phased by using offsets.

20. A method for limiting the number of crystals needed for reference oscillators when integrally combining a navigation receiver and cellphone to two, comprising:
providing a GPS oscillator with a first crystal operating at about 27-MHz;
providing a watch oscillator with a second crystal operating at about 32-KHz;
connecting a multiplier to the GPS oscillator to produce higher frequencies to operate a GPS receiver;
generating a VCO frequency with a first numeric controlled oscillator (NCO1) to operate a communications transceiver;
generating a host CPU frequency with a second numeric controlled oscillator (NCO2); and
producing time events to host CPU with logic combinations of GPS-msec interrupts, GPS-second pulses, digital offsets, and said watch oscillator.
